(19) United States
(12) Patent Application Publication
(10) Pub. No.: US 2015/0050964 A1
(43) Pub. Date: Feb. 19, 2015

(54) LOW RADIATION DOSE RATE MOBILE PHONE

(71) Applicant: YOTA DEVICES IPR LTD, Tortola (VG)

(72) Inventors: Dmitry GORILOVSKY, Nurnberg (DE); Dennis SVERDLOV, St.-Petersburg (RU)

(21) Appl. No.: 14/497,965

(22) Filed: Sep. 26, 2014

Related U.S. Application Data
(63) Continuation of application No. PCT/EP2013/056705, filed on Mar. 28, 2013.

(30) Foreign Application Priority Data
Mar. 28, 2012 (GB) 1205431.8

(51) Int. Cl. H04M 1/02; H04B 1/38

(52) U.S. Cl. CPC H04M 1/026; H04B 1/3833
USPC 455/566

(57) ABSTRACT

The field of the invention relates to mobile phones arranged to reduce a specific absorption rate of mobile phone radiation into the body of a user. There is provided a bar form factor mobile phone device comprising front and back major faces, the front major face arranged to present a first display screen and the back major face arranged to present a second display screen, wherein the device comprises an antenna operable to receive radio frequency transmissions, wherein the first and second displays have low transmission at the radio frequency transmissions, and wherein the antenna is arranged near to a side face of the device.

### BACKGROUND OF THE INVENTION

1. Field of the Invention

The field of the invention relates to bar form factor mobile phones arranged to reduce a specific absorption rate of mobile phone radiation into the body of a user. Bar form factors include slab, slate, block, bar and candybar.

2. Technical Background

The United States Federal Communications Commission (FCC) guidelines provide a maximum specific absorption rate (SAR) of mobile phone radiation into the human body of 1.6 W/kg (Watts per kilogramme). The adverse health effects of mobile phone radiation have been the subject of debate and dispute for some time. Nevertheless, the manufacturers of mobile phones should comply with limits which are established by regulatory bodies on the maximum permitted dose rate of mobile phone radiation for a mobile phone user in whatever country a mobile phone is placed on sale, or intended for use.

The mobile phone radiation dose rate from a mobile phone to the human body may be relatively high under the following conditions: when the phone is situated close to the user's head the dose rate may be relatively high to the head; when the phone is held in the user's hand the dose rate may be relatively high to the hand, and when the phone is situated in a user's garment pocket the dose rate may be relatively high to the part of the user's body next to the garment pocket.

A limitation on the maximum communications signal transmission and/or reception power of a mobile phone is placed by the maximum permissible dose rate of mobile phone radiation into the body of the human user.

In telecommunications, 3G, short for third Generation, is the 3rd generation of mobile telecommunications technology. In a broad sense, the 3G spectrum is from about 400 MHz to about 3 GHz. 4G is the fourth generation of mobile phone mobile communication technology standards. The 4G spectrum falls within the 3G spectrum in the broad sense. Radio frequency (RF) is a rate of oscillation of electromagnetic radiation in the range of about 3 kHz to 300 GHz, hence the 3G spectrum from about 400 MHz to about 3 GHz is in the radio frequency range.

3. Discussion of Related Art

In US2004/0037052A1, there is disclosed a low-radiation mobile phone which includes an electrical circuit board, which is disposed within a housing and which includes a circuit board, an antenna in electrical connection with the circuit board for serving as one electromagnetic radiating source, and a conductive piece that has a grounding end in electrical connection with a grounding point of the circuit board, and a radiating end for serving as another electromagnetic radiating source. It is disclosed that because there are two electromagnetic radiating sources in the mobile phone, the Specific Absorption Rate of the mobile phone and thus the harmful effect of the electromagnetic radiation of the mobile phone on a human body can be reduced.

US2004/0037052A1 discloses prior art FIG. 1, referring to which US2004/0037052A1 discloses a low-radiation mobile phone including a housing 1 and an electrical circuit device 2. The housing 1 includes an upper housing 11 and a lower housing 12 that are interconnected fixedly and that define an accommodation chamber therebetween for receiving the electrical circuit device 2. The electrical circuit device 2 includes an elongated circuit board 21, an antenna 22 in electrical connection with the circuit board 21, and a liquid crystal display (LCD) 23 disposed on the circuit board 21. The electrical circuit device 2 further includes a conductive piece 24 that is configured as a rigid metal wire, which has an L-shaped main wire portion (240A) and a connecting wire portion (240B) that extends integrally and perpendicularly from an end of the L-shaped main wire portion (240A). The L-shaped main wire portion (240A) extends in a plane parallel to the circuit board 21, and has a long section (240A′) extending along a longitudinal direction of the circuit board 21, and a short section (240A″) extending along a transverse direction of the circuit board 21. The conductive piece 24 has a grounding end 241 in electrical connection with a grounding point 211 on the circuit board 21, and a radiating end 242 for electromagnetic radiation emission. It is disclosed that when the grounding end 241 of the conductive piece 24 is connected electrically to the circuit board 21 (see FIG. 1) so that the antenna 22 and the radiating end 242 serve as two electromagnetic radiating sources, the value of the SAA of the mobile phone is reduced.

### SUMMARY OF THE INVENTION

According to a first aspect of the invention, there is provided a bar form factor mobile phone device comprising front and back major faces, the front major face arranged to present a first display screen and the back major face arranged to present a second display screen, wherein the device comprises an antenna operable to receive radio frequency transmissions, wherein the first and second displays have low transmission at the radio frequency transmissions, and wherein the antenna is arranged near to a side face of the device.

The bar form factor mobile phone device may be one wherein the second display screen is different to the first display screen.

The bar form factor mobile phone device may be one wherein the device is arranged such that the antenna is further operable to transmit radio frequency transmissions.

The bar form factor mobile phone device may be one wherein the radio frequency transmissions are mobile phone communications frequency transmissions.

The bar form factor mobile phone device may be one wherein the radio frequency transmissions are in the 3G spectrum.

The bar form factor mobile phone device may be one wherein the low transmission at the radio frequency transmissions for each mobile phone display corresponds to less than 10% of the radio frequency radiation being transmitted by each mobile phone display.

The bar form factor mobile phone device may be one wherein less than 1% of the radio frequency radiation is transmitted by each mobile phone display.

The bar form factor mobile phone device may be one wherein the antenna is located near to a longitudinal side face of the mobile phone.

The bar form factor mobile phone device may be one wherein the antenna is located inside housing of the longitudinal side face of the mobile phone.

The bar form factor mobile phone device may be one wherein the antenna is located near to a transverse side face of the mobile phone.

The bar form factor mobile phone device may be one wherein the antenna is located inside housing of a transverse side face of the mobile phone.

The bar form factor mobile phone device may be one wherein the antenna is located inside the device.

The bar form factor mobile phone device may be one wherein the antenna is located inside housing of the device.

The bar form factor mobile phone device may be one wherein the antenna is located under a side face of the device.

The bar form factor mobile phone device may be one wherein a spacing of pixel driving conducting circuitry within the first and second mobile phone display screens is on a scale of less than 1 mm.

The bar form factor mobile phone device may be one wherein the spacing of pixel driving conducting circuitry within the first and second mobile phone display screens is on a scale of less than 100 micrometres.

The bar form factor mobile phone device may be one wherein the device is a portable digital assistant, a digital audio player or a tablet computer.

The bar form factor mobile phone device may be one wherein the device includes a touch screen.

The bar form factor mobile phone device may be one wherein the device includes a virtual keyboard.

The bar form factor mobile phone device may be one wherein the second display screen is a bistable display screen.

The bar form factor mobile phone device may be one wherein the second display screen occupies greater than 50% of the area of the major face of the device on which it is located.

The bar form factor mobile phone device may be one wherein the second display screen occupies greater than 70% of the area of the major face of the device on which it is located.

The bar form factor mobile phone device may be one wherein the second display screen occupies greater than 90% of the area of the major face of the device on which it is located.

The bar form factor mobile phone device may be one wherein the first display screen occupies greater than 50% of the area of the major face of the device on which it is located.

The bar form factor mobile phone device may be one wherein the first display screen occupies greater than 70% of the area of the major face of the device on which it is located.

The bar form factor mobile phone device may be one wherein the first display screen occupies greater than 90% of the area of the major face of the device on which it is located.

The bar form factor mobile phone device may be one wherein the mobile phone antenna is a patch antenna.

The bar form factor mobile phone device may be one wherein the mobile phone antenna is an F-type antenna.

The bar form factor mobile phone device may be one wherein the mobile phone antenna is a fractal antenna.

The bar form factor mobile phone device may be one wherein the mobile phone antenna is a folded box-type antenna.

The bar form factor mobile phone device may be one wherein the mobile phone antenna is a monopole planar antenna.

The bar form factor mobile phone device may be one wherein the mobile phone antenna is a dipole planar antenna.

The bar form factor mobile phone device may be one wherein the mobile phone antenna is a planar spiral antenna.

The bar form factor mobile phone device may be one wherein the mobile phone antenna is a planar inverted F Antenna.

The bar form factor mobile phone device may be one wherein the mobile phone antenna is a grounded monopole antenna.

The bar form factor mobile phone device may be one wherein the mobile phone antenna is an array antenna.

The bar form factor mobile phone device may be one wherein the mobile phone antenna is a single band antenna.

The bar form factor mobile phone device may be one wherein the mobile phone antenna is a multi-band antenna.

The bar form factor mobile phone device may be one wherein, in use, when communicating using the antenna the mobile phone device provides a maximum specific absorption rate (SAR) of mobile phone radiation into a human body situated next to the phone below 1.6 W/kg.

The bar form factor mobile phone device may be one wherein, in use, when communicating using the antenna the mobile phone device provides a maximum specific absorption rate (SAR) of mobile phone radiation into a human body situated next to the phone below 0.5 W/kg.

The bar form factor mobile phone device may be one wherein, in use, when communicating using the antenna the mobile phone device provides a maximum specific absorption rate (SAR) of mobile phone radiation into a human body situated next to the phone below 0.2 W/kg.

The bar form factor mobile phone device may be one wherein the device includes a concave front face and a convex rear face.

The bar form factor mobile phone device may be one wherein the device includes either a concave front face or a convex rear face.

The bar form factor mobile phone device may be one wherein a distance between the antenna and the side face is less than 5 mm.

### BRIEF DESCRIPTION OF THE DRAWINGS

The above and other aspects of the invention will now be described, by way of example only, with reference to the following Figures, in which:

FIG. 1 shows prior art from US2004/0037052A1 in which there is shown a perspective view of a low-radiation mobile phone wherein a housing 1 is shown in broken lines for illustrating clearly a circuit board 21, a liquid crystal display 23, an antenna 22, and a conductive piece 24.

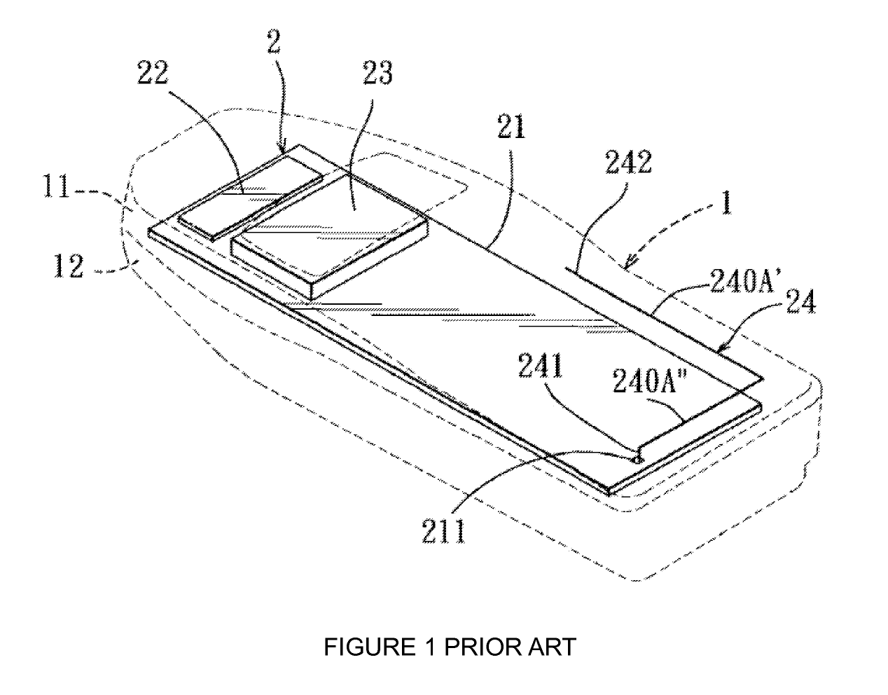

FIG. 2 shows a front perspective view of a mobile phone including a display screen on each of its front and rear major faces, in which an antenna is located inside housing of a longitudinal side face of the mobile phone.

FIG. 3 shows a rear perspective view of a mobile phone including a display screen on each of its front and rear major faces, in which an antenna (not shown) is located inside housing of a longitudinal side face of the mobile phone.

FIG. 4 shows a front perspective view of a mobile phone including a display screen on each of its front and rear major faces, in which an antenna is located inside housing of a transverse side face of the mobile phone.

FIG. 5 shows a rear perspective view of a mobile phone including a display screen on each of its front and rear major faces, in which an antenna is located inside housing of a transverse side face of the mobile phone.

### DETAILED DESCRIPTION

Typically the highest mobile phone radiation dose rates will be experienced in the user's hand which holds the mobile phone because that hand is in contact with the mobile phone over an extended contact area of the hand for extended periods of time.

The wavelengths in air of electromagnetic radiation which corresponds to the 3G spectrum frequencies from 400 MHz to 3 GHz are from about 75 cm to about 10 cm. The radiation dose rate to the hand of a mobile phone user which is holding the mobile phone may be reduced by incorporating a display on the front major face of the mobile phone and a further display on the rear major face of the mobile phone. The spacing of conducting circuitry relating to pixels within the mobile phone displays includes conducting circuitry which may be spaced on a scale of less than 1 mm; in some examples the conducting circuitry may be spaced on a scale of less than 100 micrometres. This scale is much smaller than the wavelength of typical mobile phone radiation. The display has a low transmission for the mobile phone radiation and accordingly the dose rate of mobile phone radiation into the hand of the user is reduced, irrespective of whether the user's hand holds the rear face of the mobile phone so the user may view the front display, or if the user's hand holds the front face of the mobile phone so the user may view the rear display.

The first display screen and the second display screens may each occupy a relatively large fraction of the area of their respective major faces, in order to reduce the dose rate of mobile phone radiation to the hand of a user when in contact with that face.

An antenna for transmitting or receiving radio frequency communications, such as frequencies in the 3G spectrum, may be arranged near to a side face of the device; the distance between the antenna and the side face may be less than 5 mm. This arrangement provides efficient transmission or reception. An antenna arranged more centrally within the device would lead to increased mobile phone radiation absorption by the front and rear mobile phone screens, which would require increased powering of the antenna for equivalent transmission or reception strength, which could pose a mobile phone radiation dose rate risk to a user of the mobile device.

The antenna may be arranged near to a transverse side face of the device. An advantage is that users more typically grip a mobile phone around its longitudinal sides, hence mobile phone radiation dose rate to a user may be typically reduced. The antenna may be arranged near to a longitudinal side face of the device. An advantage is that the longitudinal side faces typically have lengths that are well suited to accommodate the lengths of mobile phone antennas. The antenna may be located inside the device. An advantage is that the mobile phone antenna is less likely to be broken in a mechanical impact e.g. when a device is dropped accidentally. The antenna may be located under a side face of the device. An advantage is that the antenna is protected from coming into contact with external metal objects, which could alter its characteristic frequency or characteristic frequencies.

A low transmission of mobile phone radiation for a mobile phone display corresponds to less than 10% of the mobile phone radiation being transmitted by the mobile phone display. A very low transmission of mobile phone radiation for a mobile phone display corresponds to less than 1% of the mobile phone radiation being transmitted by the mobile phone display. When the fraction of a major face of the mobile phone that is taken up by a display is increased, the mobile phone radiation dose rate into the hand of a user in contact with that major face is reduced.

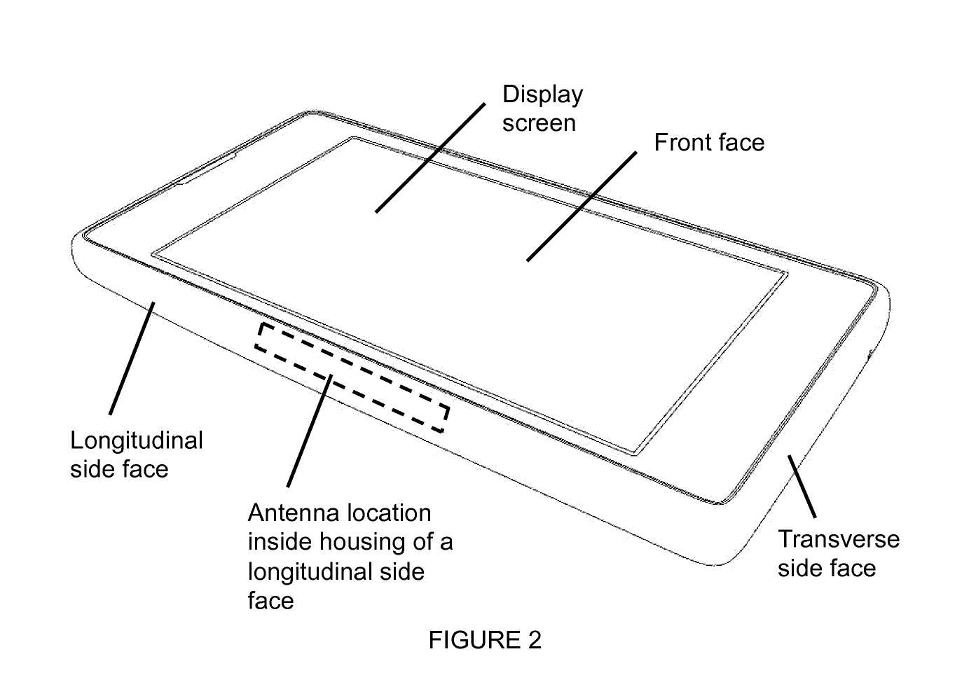

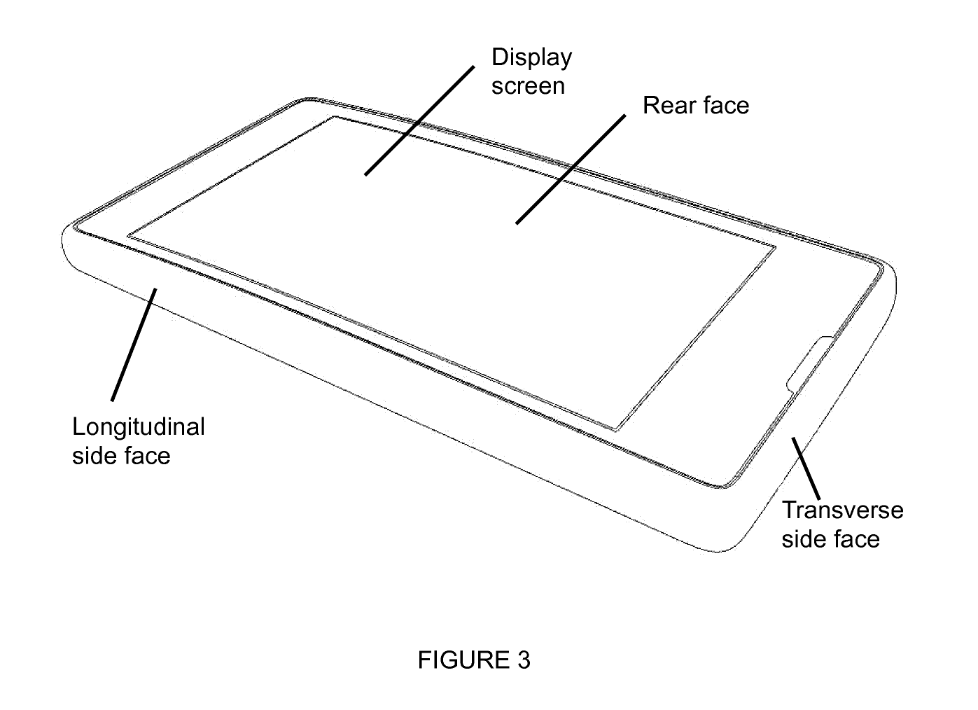

In an example, a mobile phone device is provided including a front major face and a rear major face, in which the front major face includes a first display screen and in which the rear major face includes a second display screen, the device further including upper and lower transverse side faces, the device further including left and right longitudinal side faces, in which an antenna for receiving radio frequency transmissions, such as mobile phone communications transmissions, is provided inside the housing of a longitudinal side face. An example is shown in FIG. 2 and in FIG. 3. In FIG. 2, the antenna location is shown in dashed lines to indicate that it is within the housing of the mobile phone device. The first display screen and the second display screen may each occupy a relatively large fraction of the area of their respective major faces, in order to reduce the dose rate of mobile phone radiation to the hand of a user when in contact with that face.

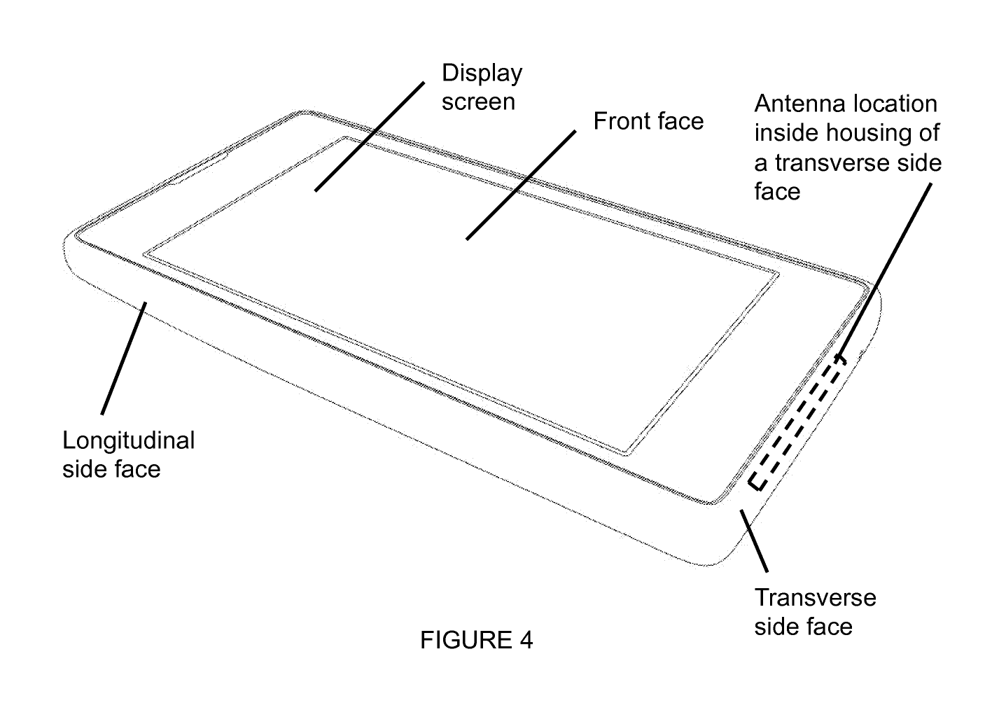

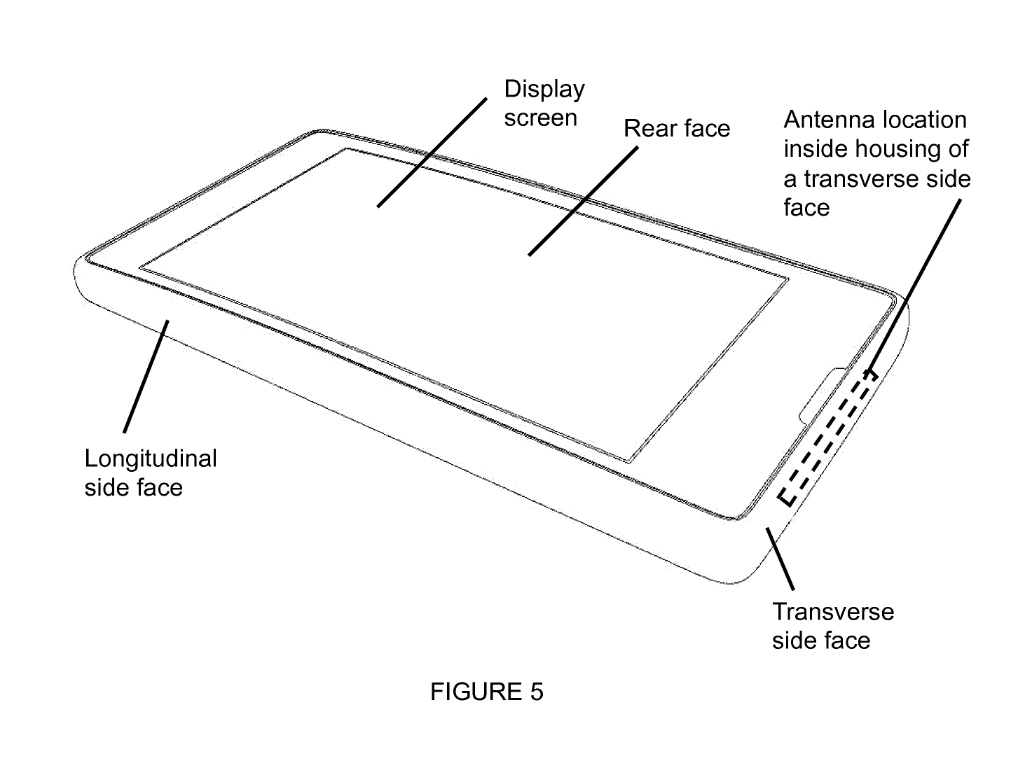

In an example, a mobile phone device is provided including a front major face and a rear major face, in which the front major face includes a first display screen and in which the rear major face includes a second display screen, the device further including upper and lower transverse side faces, the device further including left and right longitudinal side faces, in which an antenna for receiving radio frequency transmissions, such as mobile phone communications transmissions, is provided inside the housing of a transverse side face. An example is shown in FIG. 4 and in FIG. 5. In FIG. 4 and in FIG. 5, the antenna location is shown in dashed lines to indicate that it is within the housing of the mobile phone device. The first display screen and the second display screen may each occupy a relatively large fraction of the area of their respective major faces, in order to reduce the dose rate of mobile phone radiation to the hand of a user when in contact with that face.

The device may be portable. The device may be a mobile phone, a portable digital assistant, a digital audio player or a tablet computer. Known digital audio players include the ipod and mp3 players. Known tablet computers include the ipad. The device may include a virtual keyboard. The device may have a touch screen. The device may have two screens each of which is a touch screen. The back display screen may be a bi-stable display screen. The bi-stable screen may be a touch screen. A screen that is not a bi-stable screen may be a touch screen. The device may include a second bi-stable screen. The device may include a second bi-stable screen which is a touch screen. The device may include a second bi-stable screen which is not a touch screen. The front display screen may be a liquid crystal display screen, an organic light emitting display screen or a bi-stable screen. A bi-stable screen may be an E-Ink screen.

The first display screen may occupy greater than 50% of the area of the major face of the device on which it is located. The first display screen may occupy greater than 60% of the area of the major face of the device on which it is located. The first display screen may occupy greater than 70% of the area of the major face of the device on which it is located. The first display screen may occupy greater than 80% of the area of the major face of the device on which it is located. The first display screen may occupy greater than 90% of the area of the major face of the device on which it is located. The first display screen may occupy greater than 95% of the area of the major face of the device on which it is located.

The second display screen may occupy greater than 50% of the area of the major face of the device on which it is located. The second display screen may occupy greater than 60% of the area of the major face of the device on which it is located. The second display screen may occupy greater than 70% of the area of the major face of the device on which it is located. The second display screen may occupy greater than 80% of the area of the major face of the device on which it is located. The second display screen may occupy greater than 90% of the area of the major face of the device on which it is located. The second display screen may occupy greater than 95% of the area of the major face of the device on which it is located.

The mobile phone antenna may be for example a patch antenna, an F-type antenna, a fractal antenna, a folded box-type antenna, a monopole planar antenna, a dipole planar antenna, a planar spiral antenna, a planar inverted F Antenna, a grounded monopole antenna or an array antenna, as would be clear to one skilled in the art. The mobile phone antenna may be a single band antenna or a multi-band antenna.

In an example, a mobile phone when communicating using the antenna provides a maximum specific absorption rate (SAR) of mobile phone radiation into the human body below 1.6 W/kg. In an example, a mobile phone when communicating using the antenna provides a maximum specific absorption rate (SAR) of mobile phone radiation into the human body below 0.5 W/kg. In an example, a mobile phone when communicating using the antenna provides a maximum specific absorption rate (SAR) of mobile phone radiation into the human body below 0.2 W/kg.

Further Aspects

In an example, there is provided a bar form factor display device comprising front and back major faces, the front major face arranged to present a first display screen and the back major face arranged to present a second display screen different to the first display screen, wherein the device comprises an antenna operable to receive radio frequency transmissions, wherein the first and second displays have low transmission at the radio frequency transmissions, and wherein the antenna is arranged near to a side face of the device. The antenna may be located inside the device. The antenna may be located under a side face of the device.

The distance between the antenna and the side face may be less than 5 mm.

The bar form factor display device may be one in which the second display screen uses electrowetting technology.

The bar form factor display device may be one in which the second display screen is a Grayscale panel.

The bar form factor display device may be one in which the second display screen is a bi-stable display screen.

The bar form factor display device may be one in which a device appearance can be changed by changing what is displayed on the bi-stable display screen.

The bar form factor display device may be one in which the bi-stable display screen is a bi-stable active matrix and high-resolution display screen.

The bar form factor display device may be one in which the bi-stable display screen is an E-ink bi-stable display screen.

The bar form factor display device may be one in which the second display screen is Electronic Paper Display under glass.

The bar form factor display device may be one in which the second display screen uses interferometric modulation technology.

The bar form factor display device may be one in which the device appearance is context-related.

The bar form factor display device may be one in which the context-related device appearance includes location-based advertising.

The bar form factor display device may be one in which the context-related device appearance includes results of a location-based search.

The bar form factor display device may be one in which the device appearance can be changed to give an appearance of a different phone case.

The bar form factor display device may be one in which the device skin can be changed.

The bar form factor display device may be one in which the device skin is one or more of wallpaper, photos, movies, or user-customized content.

The bar form factor display device may be one in which the back face appears to be part of a device case.

The bar form factor display device may be one in which the second display screen has a low power consumption.

The bar form factor display device may be one in which the first display screen and the second display screen have similar resolutions.

The bar form factor display device may be one in which the second display screen provides approximately at least 1000 full screen updates using 300 mAh of charge, for a screen size of approximately 4 inches.

The bar form factor display device may be one in which the second display screen is operable to update at a rate the order of twice per minute.

The bar form factor display device may be one in which the second screen does not consume power or require power when in a bi-stable state.

The bar form factor display device may be one in which the device displays an image in an off state or in a low power notification mode.

The bar form factor display device may be one in which an application or service executing on the device is able to display a notification on the second screen.

The bar form factor display device may be one in which any application or service executing on the device is able to display a notification on the second screen.

The bar form factor display device may be one in which a time period for which a notification is displayed is not limited.

The bar form factor display device may be one in which an application or service executing on the device is able to display a notification on the first screen.

The bar form factor display device may be one in which any application or service executing on the device is able to display a notification on the first screen.

The bar form factor display device may be one in which a message is provided on the first screen and on the second screen.

The bar form factor display device may be one in which the second display screen output provides one or more of: Interactions, Control, Use cases, Personalization, Widgets, Privacy.

The bar form factor display device may be one in which the second display screen output provides a social network screen.

The bar form factor display device may be one in which the second display screen output provides social aggregator output or social network output.

The bar form factor display device may be one in which the social aggregator output or social network output is a Facebook page.

The bar form factor display device may be one in which the second display screen output provides a Google search page.

The bar form factor display device may be one in which the second display screen output provides device location.

The bar form factor display device may be one in which the second display screen output provides Notifications.

The bar form factor display device may be one in which the second display screen output provides Operator Push output.

The bar form factor display device may be one in which the second display screen output provides news provided by a news service.

The bar form factor display device may be one in which the second display screen output provides social messages provided by a social messaging service.

The bar form factor display device may be one in which the second display screen output provides social messages provided by a social networking service.

The bar form factor display device may be one in which the second display screen output provides calendar information.

The bar form factor display device may be one in which the second display screen is the only operational display screen of the device when the device operates in a low power notification mode.

The bar form factor display device may be one in which the second display screen displays content updates of one or more categories when the device operates in a low power notification mode.

The bar form factor display device may be one in which the categories include one or more of news, social messages, an emergency notification, financial news, earthquake, tsunami or weather.

The bar form factor display device may be one in which the categories are preselected.

The bar form factor display device may be one in which the categories are preselected by a user.

The bar form factor display device may be one in which the categories are preselected by a network services provider.

The bar form factor display device may be one in which the device is a slate device.

The bar form factor display device may be one in which the device is a bar or candybar device.

The bar form factor display device may be one in which the device is a slab-shaped form.

The bar form factor display device may be one in which the first display screen is a liquid crystal display screen.

The bar form factor display device may be one in which the first display screen is an active-matrix organic light-emitting diode display screen.

The bar form factor display device may be one in which in an ON state, the front face is back-illuminated and can display an image or other content; in the ON state, the hi-stable display on the back face also can display an image or other content.

The bar form factor display device may be one in which the device comprises a touch screen.

The bar form factor display device may be one in which the first display screen is a touch screen.

The bar form factor display device may be one in which the second display screen is a bi-stable display touch screen.

The bar form factor display device may be one in which the second display screen is a bi-stable display screen and the device includes a second bi-stable screen.

The bar form factor display device may be one in which the second display screen is a bi-stable display screen and the bi-stable screen occupies greater than 70% of the area of the major face of the device on which it is located.

The bar form factor display device may be one in which the bi-stable screen occupies greater than 90% of the area of the major face of the device on which it is located.

The bar form factor display device may be one in which the bi-stable screen occupies greater than 95% of the area of the major face of the device on which it is located.

The bar form factor display device may be one in which the first screen occupies greater than 70% of the area of the major face of the device on which it is located.

The bar form factor display device may be one in which the first screen occupies greater than 90% of the area of the major face of the device on which it is located.

The bar form factor display device may be one in which the first screen occupies greater than 95% of the area of the major face of the device on which it is located.

The bar form factor display device may be one in which the device is portable.

The bar form factor display device may be one in which the device is a mobile phone, a portable digital assistant, a laptop, a digital audio player (e.g. ipod), or a tablet computer (e.g. ipad), or a smartphone.

The bar form factor display device may be one in which the device includes a virtual keyboard.

The bar form factor display device may be one in which the device includes a concave front face and a convex rear face. The bar form factor display device may be one in which the device includes either a concave front face or a convex rear face.

The bar form factor display device may be one in which the magnitudes of the curvatures of the front face and the rear face are the same or similar.

The bar form factor display device may be one in which the curvature of front and back is cylindrical.

The bar form factor display device may be one in which the curvature of front and back is spherical.

The bar form factor display device may be one in which the curvature of front and back is aspherical.

The bar form factor display device may be one in which the device has a resting position with its front face down which is mechanically stable.

The bar form factor display device may be one in which the device concave front curvature matches the path of a finger as the user's wrist rotates.

The bar form factor display device may be one in which if the bar form factor display device is placed back down (i.e. convex face down), the bar form factor display device can spin.

The bar form factor display device may be one in which if the bar form factor display device is placed in a leg pocket of a user's clothing with the concave face facing the leg, this provides better antenna reception than if the convex face faces the leg.

The bar form factor display device may be one in which a curved front face is a vibrating distributed mode loudspeaker (DML) speaker.

The bar form factor display device may be one in which a curved rear face is a vibrating distributed mode loudspeaker (DML) speaker.

The bar form factor display device may be one in which during manufacturing the curved shape is laminated to glass.

Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. Bar form factor mobile phone device comprising front and back major faces, the front major face arranged to present a first display screen and the back major face arranged to present a second display screen, wherein the device comprises an antenna, arranged near to a side face of the device, operable to receive radio frequency transmissions, wherein the first display screen comprises a driving conducting circuitry with a spacing of pixel for maintaining low transmission at the radio frequency transmissions and second display screen comprises a driving conducting circuitry with a spacing of pixel for maintaining low transmission at the radio frequency transmissions.

2. (canceled)

3. Bar form factor mobile phone device of claim 1, wherein the device is arranged such that the antenna is further operable to transmit radio frequency transmissions.

4. Bar form factor mobile phone device of claim 1, wherein the radio frequency transmissions are mobile phone communications frequency transmissions.

5. Bar form factor mobile phone device of claim 4, wherein the radio frequency transmissions are in the 3G spectrum.

6-7. (canceled)

8. Bar form factor mobile phone device of claim 1, wherein the antenna is located near to a longitudinal side face of the mobile phone.

9. Bar form factor mobile phone device of claim 8, wherein the antenna is located inside housing of the longitudinal side face of the mobile phone.

10. Bar form factor mobile phone device of claim 1, wherein the antenna is located near to a transverse side face of the mobile phone.

11. Bar form factor mobile phone device of claim 10, wherein the antenna is located inside housing of a transverse side face of the mobile phone.

12. Bar form factor mobile phone device of claim 1, wherein the antenna is located inside the device.

13. Bar form factor mobile phone device of claim 12, wherein the antenna is located inside housing of the device.

14. Bar form factor mobile phone device of claim 12, wherein the antenna is located under a side face of the device.

15. Bar form factor mobile phone device of claim 1, wherein the spacing of pixel driving conducting circuitry within the first and second mobile phone display screens is on a scale of less than 1 mm.

16. Bar form factor mobile phone device of claim 1, wherein the spacing of pixel driving conducting circuitry within the first and second mobile phone display screens is on a scale of less than 100 micrometres.

17. Bar form factor mobile phone device of claim 1, wherein the device is a portable digital assistant, a digital audio player or a tablet computer.

18. Bar form factor mobile phone device of claim 1, wherein the device includes a touch screen.

19. (canceled)

20. Bar form factor mobile phone device of claim 1, wherein the second display screen is a bistable display screen.

21-26. (canceled)

27. Bar form factor mobile phone device of claim 1, wherein the mobile phone antenna is a patch antenna.

28. Bar form factor mobile phone device of claim 1, wherein the mobile phone antenna is an F-type antenna, a fractal antenna, a folded box-type antenna, a monopole planar antenna, a planar spiral antenna, a planar inverted F Antenna, a grounded monopole antenna, an array antenna, a single band antenna or a multi-band antenna.

29-38. (canceled)

39. Bar form factor mobile phone device of claim 1, wherein, in use, when communicating using the antenna the mobile phone device provides a maximum specific absorption rate (SAR) of mobile phone radiation into a human body situated next to the phone below 1.6 W/kg.

40-41. (canceled)

42. Bar form factor mobile phone device of claim 1, wherein the device includes a concave front face and a convex rear face.

43. Bar form factor mobile phone device of claim 1, wherein the device includes either a concave front face or a convex rear face.

44. Bar form factor mobile phone device of claim 1, wherein a distance between the antenna and the side face is less than 5 mm.
